(19) United States
(12) Patent Application Publication
(10) Pub. No.: US 2011/0138674 A1
(43) Pub. Date: Jun. 16, 2011

(54) Animal attractant system

(76) Inventor: Todd Kuhn, North East, MD (US)

(21) Appl. No.: 12/653,447

(22) Filed: Dec. 14, 2009

(51) Int. Cl. A01M 31/00; A01M 31/06

(52) U.S. Cl. 43/1; 43/2

(57) ABSTRACT

A deployable device is used to attract animals to a desired location using a combination of ultraviolet brighteners for visual interest and one or more of scent, salt, and motion. The invention capitalizes on the link between many animals' ability to see ultraviolet light with their desire to investigate excretions or secretions, such as urine or pre-orbital secretions, left by other animals of the same species as territory markers.

### BACKGROUND OF THE INVENTION

1. Field of the Invention

The present invention relates to the field of hunting game animals. Specifically, the invention relates to devices used to attract game animals by stimulating several of the animal's senses.

2. Description of the Prior Art

Science has discovered some time ago that some animals possess vision capable of detecting light both in the visible spectrum (−400 to −700 nanometers wavelength) and the near ultraviolet (−200 to −400 nanometers wavelength). The evolutionary advantages afforded by this ability are varied. Many fruits, flowers, and seeds are more prominent when viewed in ultraviolet light as compared with normal visible wavelengths. Insects use ultraviolet emissions from stars and the moon to aid in flight navigation. The blood, urine, and other secretions of some animals are easily detected using ultraviolet light.

Certain fabric dyes have been found to “glow” when viewed with ultraviolet light. Clothing infused with such dyes, including clothing that appears camouflaged when viewed in visible light, is generally thought to be unsuitable for hunters. A hunter wearing such clothing appears as a bright, moving beacon to game animals. Calling attention to oneself in such a manner often frightens game animals causing them to flee.

Many common household laundry detergents include ultraviolet brighteners designed to give clothes a whiter appearance under visible light upon washing. While this is no doubt considered a positive selling point for the average consumer, for the hunter seeking to blend into the forest, using such products only compounds the problem of camouflage. An entire industry has developed to produce fabric dyes and detergents that are themselves not visible in ultraviolet light or mute ultraviolet signatures in existing off-the-shelf products.

While all the aforementioned prior art seeks to avoid detection by animals capable of seeing ultraviolet light, there is little in the prior art directed towards using an animal's ability to see ultraviolet light as an attractant. The application of Johnson (U.S. application Ser. No. 11/711,409) describes a decoy with a surface reflection that closely matches the spectral reflectance of the animal it is designed to mimic, including both human-visible and ultraviolet wavelengths in order to make the decoy appear more realistic to the target animals. However, the prior art application is limited in scope insofar as it only teaches the use of ultraviolet reflectance for lifelike mimicry. The prior art application is silent about the use of ultraviolet reflectance in combination with other attractant methods or the use of ultraviolet brighteners to render an object “super bright” as an animal attractant or to arouse curiosity in animals by deliberately failing to mimic any lifelike object that might be found in the natural environment.

### SUMMARY OF THE INVENTION

The present invention is a deployable device used to attract animals to a desired location using a combination of ultraviolet brighteners for visual interest and one or more of scent, salt, and motion. The invention capitalizes on the link between many animals' ability to see ultraviolet light with their desire to investigate excretions or secretions, such as urine or pre-orbital secretions, left by other animals of the same species as territory markers.

### BRIEF DESCRIPTION OF THE DRAWINGS

There are no drawings.

### DETAILED DESCRIPTION OF THE INVENTION

The present invention is an animal attractant system comprising a base substrate, an ultraviolet brightener, and, optionally, one or more additional attractants such as animal scent, salt, and motion. The base substrate can be fashioned into any geometry, but most advantageously such a geometry should not approximate naturally occurring shapes such as animals or plants. One such preferred geometry comprises an elongated, flat, rectangular plate roughly the size and shape of a common paint stirring stick. Another preferred geometry is an irregular, unnatural shape such as several cojoined circular disks. These and other geometries, when hung from a tree branch by a lanyard, can flutter in the breeze in a manner that piques an animal's curiosity with pleasing, natural motion while not appearing threatening. A nonthreatening yet unnatural looking object draws visual attention from far away.

In the preferred embodiment, the base substrate is fabricated from a brightly-colored material to make it visible from great distances by a human observer or hunter. The base substrate may be composed of, but not limited to, thermoplastics, thermosets, wood, and metal. Thermoplastics are preferred for their easy manipulation plus the ability to incorporate additives, such as pigments and ultraviolet brighteners, into the molten plastic instead of applying them as a surface treatment. The substrate may be fashioned by physical methods common in the art such as molding of molten materials or machining from rough stock.

The attractant system also incorporates an ultraviolet brightener, defined as a pigment, dye, or surface treatment that renders the base substrate brightly reflective or fluorescent in near ultraviolet light (−200 to −400 nanometer wavelength). This is a key feature of the present invention. One such commercially available optical brightener is 2,2′-(2,5-thiophenediyl)bis(5-tert-butylbenzoxazole), trade named Benetex® OB (CAS #7128-64-5) and manufactured by Mayzo Corporation.

In the preferred embodiment, the base substrate is fabricated from a flexible, porous ethylene vinyl acetate (EVA) copolymer that can be charged with a natural or synthetic animal scent attractant. The scent attractant may comprise, but is not limited to, any combination of animal-derived oil secretion, musk, urine, pheromone, pre-orbital gland secretion, and proprietary synthetic attractant. In the preferred embodiment, the scent attractant is packaged separately from the base substrate. Just prior to deployment, the scent attractant, which may comprise a liquid, aerosol, or semi-solid, is applied to the outer surface of the base substrate. At periodic intervals (daily, weekly, etc.), the base substrate may be recharged with the scent material.

Many wild animals crave salt. The base substrate of the present invention can be impregnated, coated, or co-mingled with crystalline salt, typically common sodium chloride, as a way of enticing wild animals to repeatedly return to the invention. While scents may attract animals once, their dietary need for salt will condition them to return regularly.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. An animal attractant system comprising:
a base substrate, and
an ultraviolet brightener that renders said base substrate brightly fluorescent in near ultraviolet light,
wherein near ultraviolet light is defined as light with a wavelength of between about 200 and about 400 nanometers.

2. An animal attractant system according to claim 1,
wherein said ultraviolet brightener comprises one of a pigment, dye, or surface treatment.

3. An animal attractant system according to claim 1,
wherein said base substrate comprises a geometry that does not approximate naturally occurring plant or animal shapes.

4. An animal attractant system according to claim 1,
further comprising a scent attractant.

5. An animal attractant system according to claim 4,
wherein said scent attractant comprises one of animal oil secretion, musk, urine, pheromone, pre-orbital gland secretion, or synthetic attractant.

6. An animal attractant system according to claim 1,
further comprising a salt attractant.

7. An animal attractant system according to claim 1,
further comprising a scent attractant, and
further comprising a salt attractant.

8. An animal attractant system comprising:
a base substrate,
an ultraviolet brightener that renders said base substrate brightly fluorescent in near ultraviolet light,
a scent attractant, and
a salt attractant;
wherein near ultraviolet light is defined as light with a wavelength of between about 200 and about 400 nanometers;
wherein said ultraviolet brightener comprises one of a pigment, dye, or surface treatment;
wherein said base substrate comprises a geometry that does not approximate naturally occurring plant or animal shapes; and
wherein said scent attractant comprises one of animal oil secretion, musk, urine, pheromone, pre-orbital gland secretion, or synthetic attractant.
